(19) United States
(12) Patent Application Publication
(10) Pub. No.: US 2026/0321136 A1
(43) Pub. Date: Oct. 15, 2026

(54) METHODS FOR AUTOMATED NOTIFICATIONS OF DRIVER BEHAVIOR

(71) Applicant: Harman Becker Automotive Systems GmbH, Karlsbad (DE)

(72) Inventors: Sridhar Vellenki Reddy, Bangalore (IN); Kaustubh Ashok Gandhi, Filderstadt (DE)

(21) Appl. No.: 19/462,922

(22) Filed: Jan. 28, 2026

(30) Foreign Application Priority Data
Feb. 5, 2025 (IN) 202541009515

(51) Int. Cl. G08G 1/0965; G08G 1/09; G08G 1/0967

(52) U.S. Cl. CPC G08G 1/0965; G08G 1/091; G08G 1/096741; G08G 1/096791

(57) ABSTRACT

The disclosure herein pertains to automatically transmitting an event to one or more vehicles within a threshold proximity of the event. A method includes determining a presence of an inattentive vehicle operator in a first vehicle and transmitting to one or more vehicles within a threshold proximity of the first vehicle the presence of the inattentive vehicle operator.

### CROSS REFERENCE TO RELATED APPLICATIONS

The present application claims priority to Indian Patent Application No. 202541009515, filed on Feb. 5, 2025. The entire contents of the above-listed application are hereby incorporated by reference for all purposes.

### FIELD

The disclosure relates to methods and apparatuses for detection and indication of a driver behavior and alerting other vehicles of the driver behavior.

### Background and Summary

Vehicle-to-everything (V2X) communication is the process of broadcasting basic safety messages (BSM) from a vehicle to any V2X device that may affect the vehicle, and vice versa. V2X includes several types of communication, such as vehicle-to-infrastructure (V2I), vehicle-to-network, vehicle-to-vehicle, and vehicle-to-pedestrian. V2X communication allows for communication between the vehicle and other entities which may increase road safety, traffic efficiency, energy savings, avoidance of traffic violations, and minimization of ambiguities. V2I safety applications that are supported by a vehicle, (e.g., an on board unit (OBU) of the vehicle) provide a driver of the vehicle with an early alert/warning based on configurable thresholds. The thresholds are predefined and developed through different pilot tests, different configurations, different user experiences, different vehicle capabilities, different terrains, different lanes, different regions, different vehicle classes, and so on. A host vehicle may trigger an early warning/alert (e.g., 5 seconds ahead of a collision/threat/violation) by indicating to the driver when a V2X remote vehicle approaches the host vehicle or when the host vehicle is about to violate traffic rules, for example.

In a typical V2X system, the host vehicle receives basic safety messages (BSM) from one or more remote vehicles (e.g., a car, truck, bus, and so on) and assesses a threat (e.g., a likelihood of an event) based on the remote vehicle and host vehicle dynamics, such as speed, heading, latitude, longitude, elevation, yaw rate, acceleration CAN (controller area network) events, and other BSM information. The host vehicle may receive traveler information messages (TIMs), signal phase and timing (SPAT) messages, and map data (MAP) from one or more roadside units (RSUs), and may assess possible traffic violations based on the received V2I messages.

V2X applications can be divided up into multiple categories based on the involvement of various road actors. For example, V2I use-cases may involve a light violation warning, roadworks warning, etc. V2V use cases may involve forward collision warning, intersection movement assist, emergency electronic brake light, etc. and vehicle to pedestrian (V2P) may include adjustments to reduce events including pedestrians.

In some situations, a vehicle may operate erratically due to operator behavior and/or impairment. The vehicle may also operate erratically due to a degraded component which may limit vehicle maneuvers. The vehicle may present challenges to other on-road vehicles.

In some embodiments, the issues described above relating to identifying a vehicle operating erratically and automatically alerting other vehicles may be addressed by determining a presence of an inattentive vehicle operator in a first vehicle and transmitting to one or more vehicles within a threshold proximity of the first vehicle the presence of the inattentive vehicle operator.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 shows a communication system for communication between a cloud and a plurality of vehicles;

FIG. 2 shows an example scenario of a first vehicle approaching a second vehicle operating erratically and receiving an automatic alert;

FIG. 3 shows an example scenario for reducing an alert threshold based on upcoming conditions;

FIG. 4 shows an example scenario for reducing a vehicle reaction time;

FIG. 5 shows an example method for automatically alerting one or more vehicles of an erratic vehicle;

FIG. 6 shows an example method for reducing a vehicle detection threshold; and

FIG. 7 shows a method for reducing a vehicle detection threshold based on a number of events determined.

FIG. 8 shows a method executed by an application for signaling detection threshold adjustments to a plurality of vehicles based on conditions.

FIG. 9 shows an operating sequence of a vehicle approaching an event.

### DETAILED DESCRIPTION

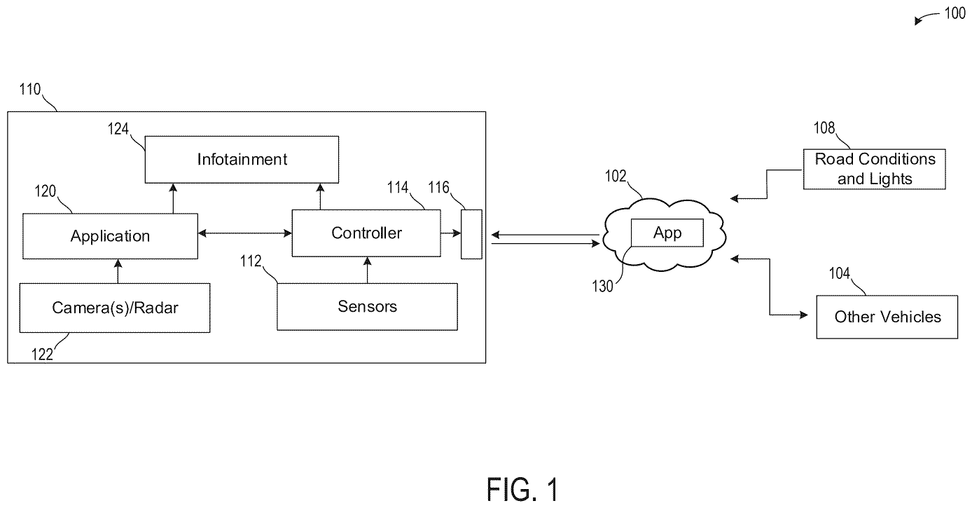

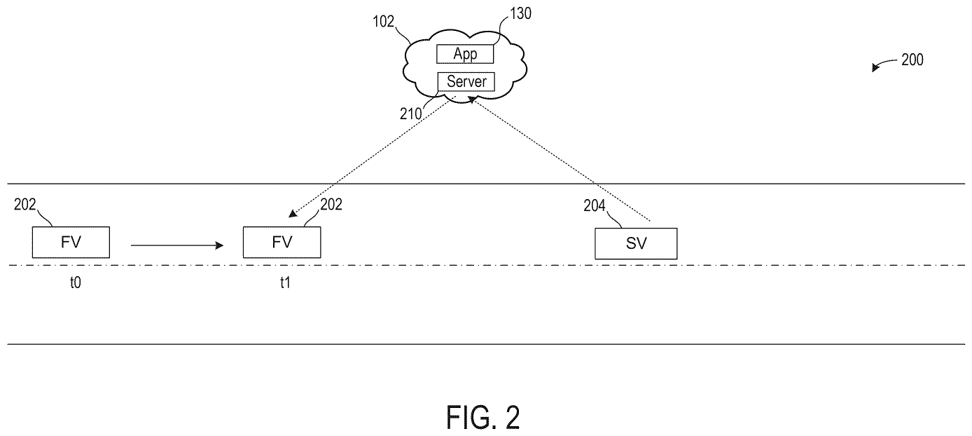

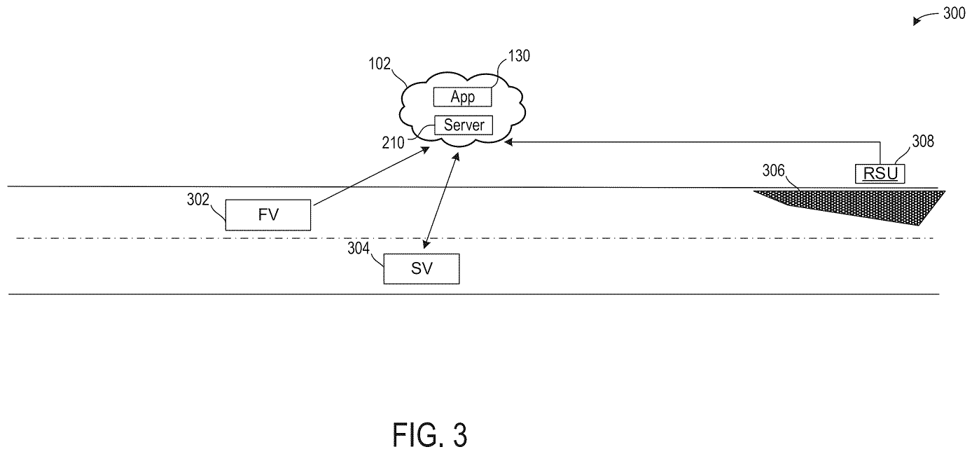

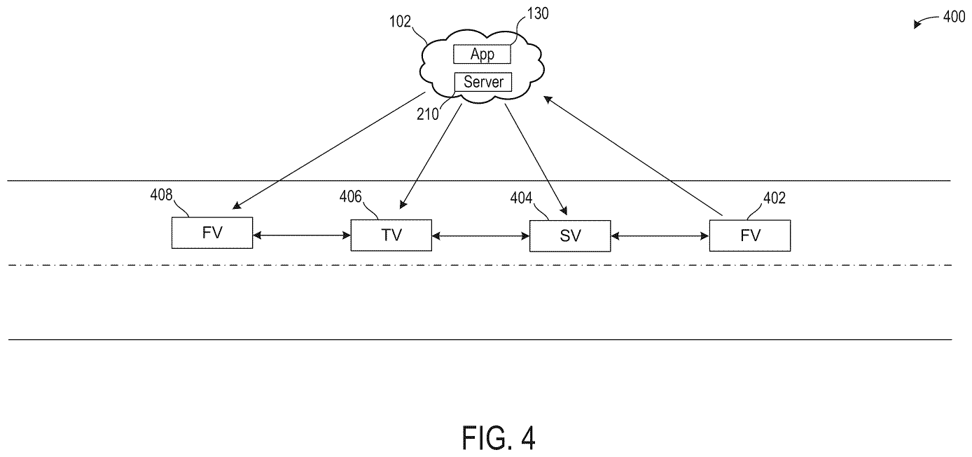

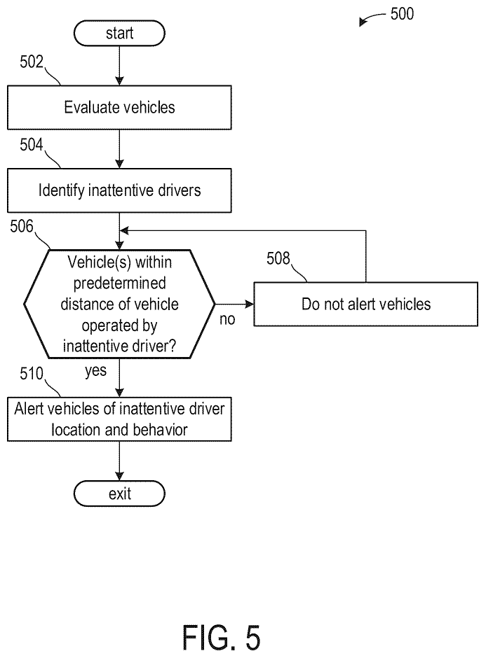

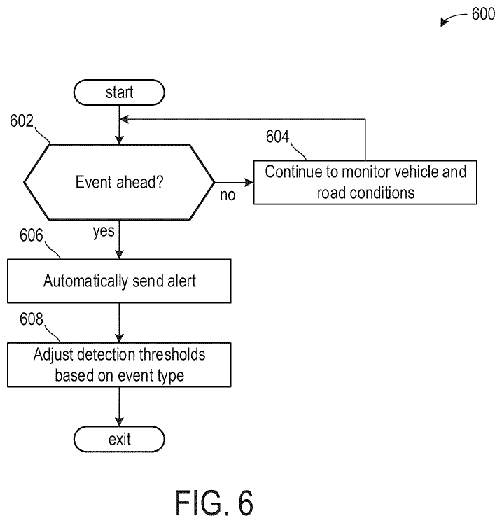

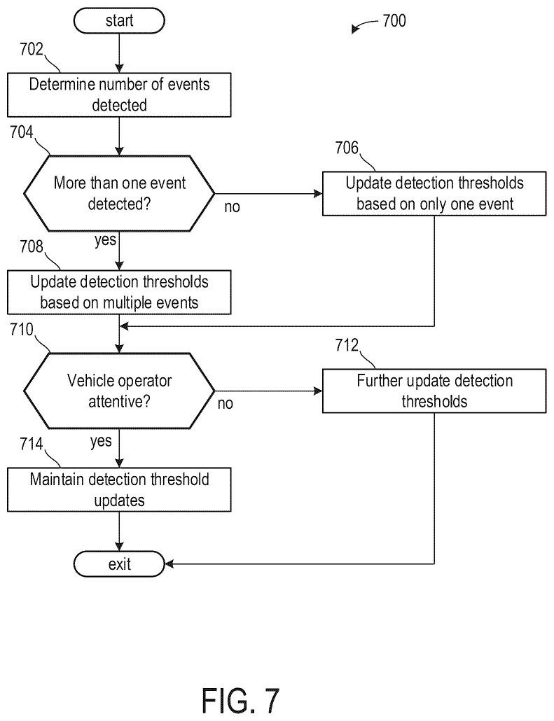

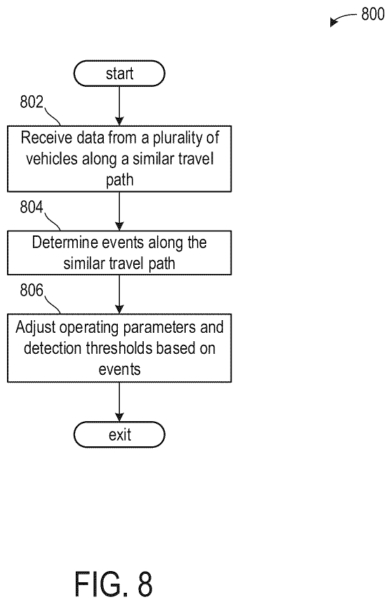

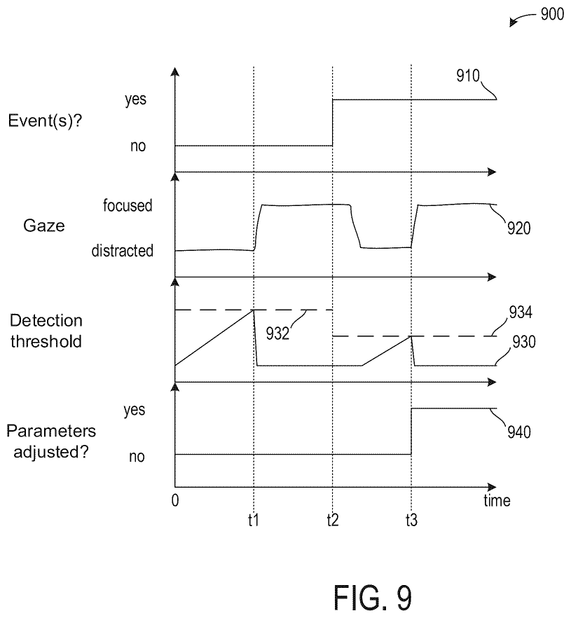

The following description relates to mechanisms and methods for alerting a vehicle of erratic behavior of another vehicle. FIG. 1 shows a communication system for communication between a cloud and a plurality of vehicles. FIG. 2 shows an example scenario of a first vehicle approaching a second vehicle operating erratically and receiving an automatic alert. FIG. 3 shows an example scenario for reducing an alert threshold based on upcoming conditions. FIG. 4 shows an example scenario for reducing a vehicle reaction time. FIG. 5 shows an example method for automatically alerting one or more vehicles of an erratic vehicle. FIG. 6 shows an example method for reducing a vehicle detection alert. FIG. 7 shows a method for reducing a vehicle detection threshold based on a number of events determined. FIG. 8 shows a method executed by an application for signaling detection threshold adjustments to a plurality of vehicles based on conditions. FIG. 9 shows an operating sequence of a vehicle approaching an event.

Turning now to FIG. 1, it shows a communication network 100 including a cloud 102. The cloud 102 may host one or more software applications, such as application 130, on memory thereof. The application 130 may be executed via a central controller and/or processor in communication with the cloud 102. The application 130 may be configured to communicate with a vehicle 110 via a communication device, such as server 210 of FIG. 2, wherein the application 130 may signal vehicle operating adjustments based on data received from the vehicle 110 and a vehicle operating environment including other vehicles 104 and road conditions and lights 108.

In one example, the application 130 may receive data and analyze the data based on current conditions and previous conditions to determine if adjustments to operating parameters and detection thresholds are desired. The application 130 may then signal to the vehicle 110 and the other vehicle 104 the determined adjustments.

The vehicle 110 and the application 130 may dynamically communicate with one another. The vehicle 110 may include a plurality of sensors 112 in communication with a vehicle controller (e.g., an in-vehicle computing system) 114. The plurality of sensors may include a global navigation satellite system (GNSS), a controller area network (CAN), vehicle speed, and other sensors. When outputting data, an inter-vehicle system communication module 116 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System (GPS) sensors, and so on), digital signals propagated through vehicle data networks (such as a motor CAN bus through which motor-related information may be communicated, a climate control CAN bus through which climate control related information may be communicated, and a multimedia data network through which multimedia data is communicated between multimedia components in the vehicle). For example, vehicle controller 114 may retrieve from the engine CAN bus a current speed of the vehicle estimated by the wheel sensors, a power state of the vehicle via a battery and/or power distribution system of the vehicle, an ignition state of the vehicle, and so on. In addition, other interfacing means such as Ethernet may be used as well without departing from the scope of this disclosure.

The vehicle 110 may further include an in-vehicle application 120. The in-vehicle application 120, which may include a driver monitoring system (DMS), may be in communication with the vehicle controller 114 and one or more cameras and radar 122. The one or more cameras may be in-cabin cameras configured to monitor a status of a vehicle operator. Herein, the vehicle operator may be interchangeably referred to as a driver without departing from the scope of the present disclosure. For example, the one or more cameras may capture images of the vehicle operator. The in-vehicle application 120 may receive the images and monitor an awareness of the vehicle operator based on comparisons of images taken over time, wherein the comparisons determine if the vehicle operator is becoming less attentive and/or sleepy. The in-vehicle application 120 may communicate with the vehicle operator via vehicle infotainment system 124, such as a display device of the vehicle. The communication from the in-vehicle application 120 to the vehicle operator via the vehicle infotainment system 120 may include vibrations, sounds, and/or messages prompting the vehicle operator to take a break, consume a caffeinated consumable, and/or notify the vehicle operator that certain behaviors are being perceived as erratic and/or inattentive. Additionally, or alternatively, an emotional state (e.g., angry, sad, joyous, etc.) of the vehicle operator may be determined based on facial images acquired. The awareness of the vehicle operator may be further determined based on an operator's eye-gaze and eye-lids. For example, if operator looks outside of forward-gaze zones consistently greater than a threshold, then the vehicle operator may be inattentive. As another example, if the vehicle operator frequently blinks or elongates a closure of their eyelid while blinking, then the vehicle operator may be inattentive and/or sleepy.

If the vehicle operator continues to operate the vehicle erratically and/or inattentively, the in-vehicle application 120 may transmit the information to the vehicle controller 114, wherein the vehicle controller may transmit the information to the cloud 102 via the communication module 116. As such, the application 130 may process the data received and transmit alerts to other vehicles 104 that are within a threshold proximity and/or a predetermined distance of the vehicle 110. In one example, the transmission of the alerts to other vehicle 104 may be automatic. Automatically transmitting alerts is described in greater detail below.

It will be appreciated that the embodiments described above and below may be applied to semi-autonomous and fully autonomous vehicles. The in-vehicle application may monitor current vehicle maneuvers and determine if the vehicle maneuvers are altered relative to previous driving events, thereby monitoring attentive or inattentive driving.

In one example, current vehicle maneuvers, whether executed by the vehicle operator or autonomously (e.g., without vehicle operator input), may be compared to expected maneuvers. The expected maneuvers may be based on one or more of an average vehicle maneuver through an associated section of a vehicle travel path, previous vehicle maneuvers through the associated section of the vehicle travel path, and rules and regulations corresponding to the associated section of the vehicle travel path. The rules and regulations may include lane markings, speed limits, and local laws. In some examples, additionally or alternatively, the expected maneuvers may be further correlated to previous maneuvers based on weather conditions, time of day, public events, time of year, and the like.

In this way, a vehicle application may be in communication with a cloud application (e.g., the application 130). The cloud application may herein be interchangeably referred to as a remote vehicle monitoring system. The in-vehicle application may determine data related to a vehicle operator and/or a status of a single vehicle. The cloud application 130 may retrieve data related to a plurality of vehicles via a V2X network or other wireless communication. Similarly, vehicles may intercommunicate directly without the cloud application 130 via a V2V network or other wireless network. The cloud application and/or the in-vehicle application may determine suggested modifications to vehicle operating parameters and detection thresholds based on a proximity of the vehicles to an event, such as an inattentive driver, a caution zone, and/or a hard-stop. The cloud application and/or the in-vehicle application may transmit the event data to the plurality of vehicles, wherein the vehicle application may implement and/or modify the suggested modifications to the vehicle operating parameters.

Turning now to FIG. 2, it shows an example 200 of a first vehicle 202 approaching a second vehicle 204. In one example, the first vehicle 202 is a host vehicle and the second vehicle 204 is a remote vehicle. In one example, each of the first vehicle 202 and the second vehicle 204 may be non-limiting examples of the vehicle 110 of FIG. 1. The second vehicle 204 may be operating erratically as determined by an in-vehicle application (e.g., application 120 of FIG. 1). For example, the in-vehicle cameras and sensors may determine that a vehicle operator's gaze, which may include a view of the second vehicle 204, wanders away from the road at greater than a threshold duration and/or frequency. Herein the in-vehicle application is interchangeably referred to as a driver monitoring system (DMS).

The cloud 102 includes a server 210 that may be in communication with the first vehicle 202 and the second vehicle 204. In the example 200, the controller of the second vehicle 204 may indicate that the vehicle operator of the second vehicle is distracted and operating the vehicle erratically and/or unpredictably (e.g., not in accordance with traffic laws and/or previously learned driver behaviors and/or vehicle maneuvers) to the server 210. The server 210 may relay the data to remote vehicle monitoring system 130. The remote vehicle monitoring system 130 may receive other data related to the driving conditions to determine if any adjustments are desired for the first vehicle 202 and/or the second vehicle 204.

A vehicle operator may be determined to be distracted if their gaze departs from a vehicle travel path at a frequency or a duration greater than a distracted threshold. In one example, the distracted threshold is based on a non-zero, positive number. The distracted threshold may be based on an average or a median frequency or duration in which the vehicle operator allows their gaze to depart from the vehicle travel path. Distracted vehicle operators may further include where their gaze does not return to the vehicle travel path following an alert provided due to the distracted threshold being exceeded. The controller may be configured to provide the alert in response to the distracted threshold being exceeded (e.g., a vehicle operator gaze being directed away from the vehicle travel path for longer than the distracted threshold). The remote vehicle monitoring system 130, operated by the server 210 and stored in the cloud 102, may determine when to automatically alert other vehicles approaching the second vehicle. As the first vehicle 202 travels from a first location at time t0 to a second location at time t1, the first vehicle 202 reduces a distance between it and the second vehicle 204. At the second location, the server 210 transmits an alert to the first vehicle 202 indicating an erratic vehicle is ahead based on the guidance of the remote vehicle monitoring system 130. The alert may include a plurality of data including a make, a model, a year, a color, a vehicle type (e.g., sedan, truck, sport utility vehicle (SUV), motorcycle, etc.), a behavior state (e.g., speeding, swerving, hard-stop, poor operator health, etc.), and suggestions for safely driving near and/or past the erratic vehicle (e.g., the second vehicle).

In some examples, additionally or alternatively, the first vehicle 202 may automatically adjust operating parameters in response to receiving the alert. For example, the first vehicle 202 may decrease a vehicle speed, change lanes, anticipate assisting a vehicle operator maneuver (e.g., steering, slowing, and increasing speed), and the like. In this way, the vehicle operator and the vehicle controller of the first vehicle 202 may be more anticipatory of an upcoming event, such as the erratic/inattentive vehicle operator of the second vehicle 204.

Additionally, or alternatively, the remote vehicle monitoring system 130 may signal to adjust detection thresholds of the first vehicle 202 based on operation of the second vehicle 204. The controller of the first vehicle 202 may receive the signal and signal to the DMS to adjust the detection thresholds based on the output of the remote vehicle monitoring system 130. Adjusting the detection thresholds, which include the distraction threshold, may include reducing the detection thresholds, which may result in alert being triggered faster relative to the detection thresholds prior to the adjustment.

Turning now to FIG. 3, it shows an example 300 including a first vehicle 302, a second vehicle 304, and a caution zone 306. Each of the first vehicle 302, the second vehicle 304, and the caution zone 306 may be in communication with the server 210. The caution zone 306 may be in communication with the server 210 via a roadside unit (RSU) 308. The RSU 308 may include at least one wireless device for signal broadcasting, one or more processors, a wireless interface for sending transmissions to onboard units (OBUs), and a non-transitory memory having executable instructions that, when executed, cause the one or more processors to detect parameters of a lane, generate, in response to detection of parameters of the lane, a traveler information message (TIM) having a payload which indicates the parameters of the lane, and broadcast the TIM over a wireless interface.

Additionally, or alternatively, the caution zone 306 may be reported to the server 210 via another vehicle currently or previously in proximity with the caution zone 306. For example, onboard cameras of the vehicle may visualize the caution zone 306 and transmit the data to the remote vehicle monitoring system 130. Additionally, or alternatively, the caution zone 306 may be reported based on historical data and weather patterns. For example, if the caution zone 306 is an area in which it is common for ice, puddles, or other conditions to develop due to weather, then current weather conditions may indicate the presence or absence of the caution zone 306.

The RSU 308 may facilitate communication between a transportation infrastructure and OBUs of vehicles by exchanging V2X safety messages (e.g., at least one TIM) over a wireless communication medium, which may include Wi-Fi DSRC protocol compliant mediums, cellular-V 2X protocol (e.g., 4G) compliant mediums, and 5G protocol compliant mediums, in compliance with automotive standards and region specific standards. In some examples, the RSU 308 may be a virtual RSU and hosted on a cloud, such as cloud 102, as software without a physical device.

The RSU 308 may be integrated with a backhaul system, which may enable remote management (e.g., operation and maintenance) of the RSU, and may provide RSU services and/or applications delivered by back office service providers to vehicles and other devices (e.g., devices configured with an OBU capable of communication with at least one RSU). Additionally, the RSU may be incorporated into local traffic control systems (e.g., an intersection traffic controller) to deliver traffic management services to vehicles and/or other mobile devices configured with an OBU.

The second vehicle 304 may be disabled and stopped on a shoulder of the road. The second vehicle 304 may be a distraction to the first vehicle 302 and other vehicles passing the second vehicle 304. The server 210 may receive data from the second vehicle 304 regarding its location, reason for stopping, and estimated time for a repair to be complete, if applicable. The server 210 may further receive a location of the second vehicle 304 along with its protrusion into a driving lane.

The caution zone 306 may correspond to a construction zone, an icy zone, a wet zone, a pot hole, an area with debris, or other condition that may alter a road condition such that a vehicle maneuver is demanded, wherein the vehicle maneuver may be a maneuver that differentiates from an expected maneuver. The expected maneuver may be expected based on tracking a plurality of vehicle traveling through the vehicle path shown in FIG. 3 when the caution zone 306 is not present. Details related to the caution zone 306, such as its type and location may be transmitted to the server 210, to the first vehicle 302, and the second vehicle 304, wherein the remote vehicle monitoring system 130 and the onboard application of the first vehicle 302 and the second vehicle 304 may analyze the data.

The first vehicle 302 may automatically receive an alert from the server 210 related to the second vehicle 304 and the caution zone 306. The application executed by the server 210 may further provide new threshold durations to account for inattentiveness while also improving driver response times to reduce a likelihood of a vehicle event.

In one example, the automatic sending of the alert from the server 210 may be based on a distance between a target location and a vehicle. As the vehicle approaches the target location and is with a threshold distance and/or a predetermined distance, then the alert may be automatically sent without user inputs or vehicle requests. The threshold distance may be a dynamic threshold, adjusted based on operating conditions of the vehicle and a type of event at the target location. The threshold distance may be a non-zero, positive number.

For example, a distraction detection threshold may be decreased for the first vehicle 302, and any other vehicle, approaching the second vehicle 304 and the caution zone 306. The distraction detection may include determining if a vehicle operator is no longer focused on the road via in-vehicle cameras directed the vehicle operator's face along with detection of the vehicle operator interacting with the vehicle infotainment system or other vehicle system. If the gaze of the operator drifts from the travel path for longer than a threshold duration or more frequently than a threshold frequency, then the distraction threshold may be exceeded

Other modified detection thresholds may include a sleep threshold and an unresponsive driver detection threshold. The sleep threshold may be based on a vehicle operator blink rate and/or a duration of eyes being closed. The unresponsive driver detection threshold may provide a prompt to the vehicle driver to apply a pressure to the steering wheel or manipulate another vehicle component. For example, the vehicle may be operating semi-autonomously and request that the vehicle operator apply a pressure to the steering wheel to indicate they are watching the vehicle travel path. If the vehicle operator stops applying a pressure to the steering wheel when prompted, then the unresponsive driver detection threshold may indicate to the controller of the vehicle that the vehicle operator is unresponsive, either due to fatigue or other distractions.

As the first vehicle 302 approaches the second vehicle 304 and the caution zone 306, the sleep threshold and the unresponsive driver detection threshold, along with other detection thresholds, may be adjusted, such that an alert and/or a prompt is more quickly presented to the vehicle operator relative to conditions where events are not upstream of the vehicle. By doing this, the vehicle operator may be more alert.

Additionally, or alternatively, the application executed by the server 210 may signal to alter an intensity, volume, and frequency of alerts provided to the vehicle operator of the first vehicle 302. Adjusting the intensity may include adjusting a brightness, color, and/or sound of the alert. Adjusting the volume may include increasing the volume of the alert. Adjusting the frequency may include displaying the alert more frequently to the vehicle operator.

By adjusting the distraction thresholds and/or alert sounds, intensity, volume and frequency, the vehicle operator(s) and their corresponding vehicles may be more prepared for the upcoming event to perform a demanded vehicle maneuver.

Turning now to FIG. 4, it shows an example 400 of a plurality of vehicles executing a hard brake. For example, a first vehicle 402 may perform a hard-stop upstream of a second vehicle 404, a third vehicle 406, and a fourth vehicle 408. Due to the arrangement of the vehicles, only the second vehicle 404 may visually identify that the first vehicle 402 has hard-stopped via one or more of onboard cameras or a vehicle operator line of sight. The second vehicle 404 may block the third vehicle 406 and the fourth vehicle 408 from visualizing the first vehicle 402, via vision systems thereof or a vehicle operator operating the third vehicle 406 and/or a vehicle operator operating the fourth vehicle 408. It may be desired to alert the third and fourth vehicles of the hard-stop to decrease a brake reaction time of the third and fourth vehicles.

In one example, the first vehicle 402 may provide data to the server 210. The remote vehicle monitoring system 130 executed on the server 210 may determine, based on the data, whether the hard-stop was due to the vehicle operator being inattentive, sleepy, distracted, intoxicated, or some other factor that may result in a vehicle operator error or if the hard-stop was due to a traffic and/or road condition that demanded the stop.

The remote vehicle monitoring system 130, which may be executed on the server 210, may generate an alert that is automatically sent to the second vehicle 404, the third vehicle 406, and the fourth vehicle 408. Detection thresholds of the vehicles may be modified upon receiving the alert, as discussed above with respect to FIG. 3, and driving parameters may also be adjusted based on the adjusted detection thresholds. For example, a vehicle speed may be prophylactically reduced. Additionally, or alternatively, a magnitude of the adjustments to the alert thresholds may be greater for the second vehicle 404 relative to the third vehicle 406 and the fourth vehicle 408. As such, adjustments to vehicle operating parameters of the second vehicle 404 may be greater than adjustments to the vehicle operating parameters of the third vehicle 406 and the fourth vehicle 408. For example, a rate of speed reduction applied to the second vehicle 404 may be greater than a rate of speed reduction applied to the third vehicle 406. By reducing the threshold times of the vehicles, if one of the vehicle operators of the second vehicle 404, the third vehicle 406, and the fourth vehicle 408 is operating their vehicle erratically, a vehicle event may be avoided as the vehicle controller and corresponding application may determine the vehicle operator is distracted and/or incapacitated to some degree. Operation of the vehicle may be adjusted based on guidelines provided by the controller and application to assist the vehicle operator to respond to the vehicle event.

In the example of FIG. 4, the distances between the vehicles may be equal. However, due to the line of sight issues described above for the third vehicle 406 and the fourth vehicle 408, the time to respond to the hard-brake of the first vehicle 402 may be reduced. Thus, the application may provide the automatic alert to the vehicles despite their differing distances to the first vehicle 402 to provide sufficient time to respond to the event associated with the first vehicle 402. By doing this, collisions and other events may be mitigated.

Turning now to FIG. 5, it shows a method 500 for automatically alerting vehicles of a vehicle being operated erratically and/or unpredictably. Instructions for carrying out method 500 and the rest of the methods included herein may be executed by a controller based on instructions stored on a memory of the controller and in conjunction with signals received from sensors of the vehicle system, such as the sensors described above with reference to FIG. 1. The controller may employ vehicle actuators of the vehicle system to adjust vehicle operation, according to the methods described below. Additionally, or alternatively, the method 500 and the rest of the methods herein may be executed by a controller and/or a processor of the cloud on which the remote vehicle monitoring system (e.g., application 130) is hosted. The in-vehicle application and cloud application may execute the methods independently of one another, wherein conclusions determined by each of the applications may be compared and used to adjust one or more thresholds and parameters of a group of associated vehicles travelling along a similar vehicle path.

The method 500 begins at 502, which includes evaluating vehicles. Evaluating vehicles may include receiving data gathered by sensors of the vehicle, such as onboard cameras and a driver monitoring system operated locally in the vehicle. The application, including one or more of the remote driver monitoring system and the driver monitoring system, may monitor the data gathered to determine a vehicle operator condition to an application. The vehicle operator condition may include a vehicle operator attentiveness, as described above, which may be determined based on comparing various operator parameters to associated detection thresholds.

Evaluating vehicles may be executed via one or more of the remote vehicle monitoring system and the in-vehicle monitoring system. The remote vehicle monitoring system may be executed via processors and/or processors associated with the cloud whereas the in-vehicle monitoring system may be executed via the controller arranged within the vehicle.

At 504, the method 500 may include identifying inattentive vehicle operators. The vehicle operators may include vehicle operators operating vehicles in communication with one another and to the remote vehicle monitoring system. Additionally, or alternatively, the vehicle operated may be within a threshold radius (e.g., within 10 vehicles lengths) of one another, travelling along a predetermined section of a travel path, and the like. In this way, vehicle operator conditions may be used to adjust operating parameters of only vehicles that may impact one another.

An inattentive vehicle operator may be identified based on multiple parameters such as eye gaze, mental state, blink rate, facial expressions, tone of voice, and the like. An in-vehicle camera or radar, or other sensor may image the vehicle operator to determine their condition (e.g., attentive, sleepy, distracted, unhealthy, etc.). Unhealthy may refer to a plurality of conditions including coughing, intoxication, fevering, congestion, and other deviations from a healthy user not experiencing the described symptoms. For example, the vehicle operator may be unhealthy if their measured a body temperature deviates from an average body temperature, wherein the body temperature of the vehicle operator may be estimated and/or measured via sensors of the vehicle. Additionally, or alternatively, a skin tone of the vehicle operator may be compared to average skin tones of the vehicle operator, wherein the vehicle operator may be unhealthy if their skin tone deviates from the average skin tones. Other vehicle operator behaviors such as blink rate, time duration in which eyelids are closed when blinking, fidgeting, frequency and duration of an eye gaze away from a vehicle travel path, and the like may be monitored by the sensors of the vehicle and learned over time for comparing to future vehicle operator behaviors to determine if the vehicle operator is unhealthy.

At 506, the method 500 may include determining whether one or more vehicles are within a predetermined distance of a vehicle being operated by an inattentive vehicle operator. The predetermined distance may be a dynamic threshold that is adjusted based on operating conditions. For example, if a vehicle is traveling faster than another vehicle toward the inattentive vehicle operator, then the predetermined distance of the vehicle may be larger than the predetermined distance of the another vehicle. If the vehicles are not within the predetermined distance of the vehicle being operated by the inattentive vehicle operator, then at 508, the method 500 may include not alerting the vehicle(s) of the vehicle operated by the inattentive driver.

If one or more vehicles is within the predetermined distance of the vehicle operated by the inattentive vehicle operator, then at 510, the method 500 may include automatically alerting the vehicle of the location and behavior of the inattentive vehicle operator. Personal information of the inattentive driver may be omitted to maintain privacy. However, details regarding the vehicle appearance and vehicle maneuvers may be transmitted to the vehicles so that the vehicle operators may identify the vehicle operated by the inattentive vehicle operator. The method may further include adjusting parameters of the vehicles including reducing detection threshold times so that other inattentive vehicle operator approaching the inattentive vehicle operator may be identified more quickly to avoid an event. Additionally, or alternatively, the vehicle operation may be adjusted to reduce automatic brake times and/or automatic vehicle steering response times in order to avoid a vehicle event. A vehicle speed may be preemptively reduced or an upper speed of the vehicle may be reduced.

Turning now to FIG. 6, it shows a method 600 for adjusting the detection thresholds of one or more vehicles approaching a caution zone, a stopped vehicle, or an erratically driven vehicle (e.g., a vehicle swerving, frequently adjusting vehicle speeds, or performing other maneuvers that deviate from an average maneuver being executed by other vehicle operators within the predetermined distance).

The method 600 begins at 602, which includes determining if an event is upstream of a vehicle along its travel path. An event may include one or more stopped vehicles, a caution zone, and/or an erratically driven second vehicle. An event may be ahead of the vehicle if the vehicle is within the predetermined distance of the event.

If an event is not ahead (e.g., an event has not occurred or one or more vehicles are not within the predetermined distance of the event), then at 604, the method may include continuing to monitor vehicle and road conditions. An automatic alert is not sent to the one or more vehicles.

If an event is ahead, then at 606, the method 600 may include automatically sending the alert. In this way, a prompt may appear on an infotainment system of the vehicle. Additionally, or alternatively, lights, sounds, and haptic feedback may be provided with the alert.

At 608, the method 600 may include adjusting detection thresholds based on an event type. Additionally or alternatively, the detection thresholds may be adjusted based on a proximity to the event. For example, if the event type is a slippery surface, the detection threshold may be adjusted by a first amount. If the event type is an inattentive vehicle operator, then the detection threshold may be adjusted by a second amount, different than the first amount. Since an event is upcoming, it may be desired to reduce the distraction threshold to ensure the vehicle operator is more attentive and thereby may prepared to respond to the event.

In one example, if multiple events are detected, then the vehicle thresholds may be adjusted in a compounding manner. For example, if an inattentive driver and a caution area are detected along a path in which the vehicle is traveling, then the detection thresholds may be adjusted by a third mount. In one example, the third amount may be less than or equal to a sum of the first amount and the second amount. Additionally, or alternatively, detection thresholds for an in-host vehicle may be adjusted differently for more attentive drivers relative to less attentive or inattentive drivers in a remote vehicle. For example, the detection thresholds may be decreased less for more attentive drivers than less attentive or inattentive drivers. In this way, the detection thresholds may be adjusted by a plurality of varying amount based on one or more events being detected.

Additionally, or alternatively, detection threshold may be adjusted differently for autonomous, semi-autonomous, and non-autonomous vehicles. In one example, the detection threshold for an autonomous vehicle may be decreased less relative to the detection threshold for the non-autonomous vehicle.

Turning now to FIG. 7, it shows a method 700 for adjusting detection thresholds of the vehicle based on a number of events detected and if the vehicle operator of the vehicle is attentive or inattentive. The detection thresholds may include a long distraction detection threshold, a sleep alert threshold, and an unresponsive driver detection threshold. The method 700 may be executed at one or more of the remote vehicle monitoring system hosted on the cloud or via the in-vehicle application hosted on memory of the controller.

The method 700 begins at 702 which includes determining a number of events detected. The events may include a hard-stop, a caution zone, pedestrian crossing and an inattentive driver. It will be appreciated than an event may include any condition along a vehicle travel path which may demand a vehicle maneuver outside of current operating conditions.

At 704, the method 700 may include determining if more than one event is detected along a path that impact one or more vehicles. If only one event is detected, then at 706, the method 700 may include updating one or more of the detection thresholds of any vehicle within a predetermined distance of the event based on the only one event. The detection thresholds may be adjusted by different amounts based on the type of threshold. The detection threshold in the host-vehicle is adjusted if the operator in the remote-vehicle is determined to be inattentive or unhealthy. In one example, the adjusted to the detection threshold(s) may be a fixed amount regardless of the type of event. As another example, if the event is an inattentive driver then a first adjustment may be implemented. If the event is a caution zone, then a second adjustment may be implemented, different than the first adjustment. If the event is a hard-stop, then a third adjustment may be implemented, wherein the third adjustment is different than the first adjustment and the second adjustment.

If more than one event is detected, then at 708, the method 700 may include updating the detection thresholds based on multiple events. For example, if the events include an inattentive driver and a caution zone, then the detection thresholds may be adjusted by a fourth adjustment, greater than each of the first through third adjustments. Additionally, or alternatively, the fourth adjustment may be less than a sum of the first and second adjustments. In another example, the fourth adjustment may be greater than or equal to a sum of the first and second adjustments. The detection thresholds may be updated by a fifth adjustment if the events include an inattentive driver and a hard-stop. The fifth adjustment may be greater than each of the first through third adjustments and different than the fourth adjustment. The fifth adjustment may be less than, equal to, or greater than a sum of the first and third adjustments. The detection thresholds may be updated by a sixth adjustment if the events include a hard-stop and a caution zone. The sixth adjustment may be greater than the first through third adjustments and different than the fourth and fifth adjustments. The sixth adjustment may be less than, equal to, or greater than a sum of the second and third adjustments. The detection thresholds may be updated by a seventh adjustment if the events include a hard-stop, a caution zone, and an inattentive driver. The seventh adjustment may be greater than each of the first through sixth adjustments. The seventh adjustment may be less than, equal to, or greater than a sum of the first through third adjustments.

At 710, following 706 and 708, the method 700 may include determining if the vehicle operator of the vehicle receiving the updates to the detection thresholds is attentive. The attentiveness of the vehicle operator may be measured via in-vehicle sensors as described above. If the vehicle operator is not attentive, then at 712, the method 700 may include further updating the detection thresholds based on the vehicle operator's degree of inattentiveness, which may be based on a time measured for a gaze to return to the road, a length of time in which the eyes of the vehicle operator are closed, and a length of time in which the eyes of the vehicle operator are directed toward a direction of vehicle travel.

If the vehicle operator is attentive, then at 714, the method 700 may include maintain the detection threshold updates.

Turning now to FIG. 8, it shows a method 800 executed by each of the application hosted on the cloud and the in-vehicle application. In some example, only one application may be used in order to decrease manufacturing and operating costs. For example, vehicle manufacturing costs may be reduced by executing the methods of FIGS. 5-8 via a central application, such as application 130 hosted on the cloud. Additionally, or alternatively, a central application may be omitted and the methods may be executed via in-vehicle applications of a plurality of vehicles. The plurality of vehicles may communicate directly with one another or indirectly via the server regardless of only a central application being present, each of the plurality of vehicles including the application, or both.

At 802, the method 800 may include receiving data from a plurality of vehicles along a similar travel path. In one example, each vehicle of a plurality of vehicles may broadcast to other vehicles or to the remote vehicle monitoring system a travel path along which it is travelling. Each vehicle may further provide operating parameters along with parameters associated with the vehicle operator gathered via an in-vehicle driver monitoring system. The remote vehicle monitoring system and/or the in-vehicle applications may receive and analyze the data via associated controllers and processors thereof to determine if vehicle operators are distracted, performing maneuvers that are different than expected maneuvers, and the like that indicate an event is occurring.

At 804, the method 800 may include determining if one or more events are occurring along the similar travel path. If events are not occurring, then the remote and/or in-vehicle applications may not adjust any operating parameters or distraction thresholds. If events are occurring, then the remote and/or in-vehicle applications may signal to adjust operating parameters and distraction thresholds. In one example, the in-vehicle application may receive suggested adjustments from in-vehicle applications of other vehicles, wherein the suggested adjustments may be averaged with a determined adjustment of the in-vehicle application.

At 806, the method 800 may include adjusting operating parameters and detection thresholds based on the one or more events. In one example, the detection thresholds may be adjusted differently for the different vehicles travelling along the vehicle travel path. In one example, the detection thresholds for vehicles closer to the one or more events may be decreased more than vehicles farther from the one or more events. Additionally, or alternatively, vehicles within a line-of-sight of the one or more events may experience a different adjustment to detection thresholds thereof when compared to the adjustment to detection thresholds of vehicles outside of the line-of-sight of the one or more events.

Additionally, or alternatively, operating parameters of a first vehicle may be adjusted based on a signal provided by the application of a second vehicle in proximity to the first vehicle and/or the application of another vehicle in proximity to the first vehicle and/or the remote application. Proximity may include where the vehicles are within the predetermined distance of the same event.

Turning now to FIG. 9, it graphically illustrates an operating sequence 900 for a vehicle approaching an event. Plot 910 illustrates if one or more events are detected. Plot 920 illustrates a direction of a vehicle operator's gaze. Plot 930 illustrates a tracker of one or more detection thresholds. Dashed line 932 illustrates an initial detection threshold value and dashed line 934 illustrates an adjusted detection threshold value. Plot 940 illustrates if vehicle parameters are adjusted. Time increases from a left to a right side of the figure.

Prior to t1, one or more events are not detected. The vehicle operator's gaze deviates from the vehicle path and is thus, distracted. A tracker increases. The tracker monitors a value associated with the vehicle operator's distraction. For example, the tracker may track a total duration of time, a duration of time in which the driver is consecutively distracted, a frequency in which the vehicle operator's gaze is distracted, or the like.

At t1, the tracker exceeds the initial detection threshold. The initial detection threshold represents an original detection threshold that is not adjusted due to an event being detected. As such, an alert is provided at t1 to notify the vehicle operator of their distraction. Between t1 and t2, the vehicle operator gaze is determined to be focused. The tracker remains constant and does not increase due to the focused vehicle operator.

At t2, one or more events are detected. In the example of FIG. 9, the parameters are not yet adjusted. However, as described above, in some embodiments, the vehicle operating parameters may be automatically adjusted in response to the event being detected. In some example, the adjustment of the vehicle operating parameters may differ due to the type of event detected. Additionally, or alternatively, some events may trigger automatic vehicle operating parameter adjustment and other event may not. Due to the detection of the event, the original detection threshold is reduced to the adjusted detection threshold. By doing this, an alert due to distracted driving may be trigger more quickly relative to the original detection threshold.

Between t2 and t3, the vehicle operator is distracted and the tracker increases. At t3, the tracker exceeds the adjusted detection threshold and an alert is trigger. The alert notifies the vehicle operator of their distraction. Additionally, in the example of FIG. 9, the vehicle operating parameters are adjusted in response to the tracker exceeding the adjusted detection threshold. After t3, the vehicle operator gaze returns to a vehicle travel path and the vehicle operator is determined to be focused. The tracker remains constant.

The disclosure also provides support for a method including determining a presence of an inattentive vehicle operator in a first vehicle, and transmitting to one or more vehicles within a threshold proximity of the first vehicle the presence of the inattentive vehicle operator. In a first example of the method, the inattentive vehicle operator is determined based on a comparison of current maneuvers to expected maneuvers. In a second example of the method, optionally including the first example, the transmitting is automatic. In a third example of the method, optionally including one or both of the first and second examples, the method further comprises: adjusting operating parameters of the one or more vehicle in response to the presence of the inattentive vehicle operator. In a fourth example of the method, optionally including one or more or each of the first through third examples, adjusting operating parameters comprises decreasing detection thresholds. In a fifth example of the method, optionally including one or more or each of the first through fourth examples, adjusting operating parameters comprises displaying an alert to a vehicle operator and adjusting a volume, a sound, and a haptic feedback of the alert. In a sixth example of the method, optionally including one or more or each of the first through fifth examples, the method further comprises: determining a presence of an event and transmitting to the one or more vehicle within the threshold proximity of a presence of the event. In a seventh example of the method, optionally including one or more or each of the first through sixth examples, the transmitting further comprises a location and a type of the event.

The disclosure also provides support for a method including automatically transmitting an alert to a vehicle within a predetermined distance of an event. In a first example of the method, the event comprises one or more of an inattentive driver, a caution zone, and a hard-stop. In a second example of the method, optionally including the first example, the method further comprises: adjusting vehicle operating parameters in response to the alert. In a third example of the method, optionally including one or both of the first and second examples, adjusting vehicle operating parameters comprises adjusting detection thresholds. In a fourth example of the method, optionally including one or more or each of the first through third examples, adjusting vehicle operating parameters comprises adjusting a vehicle speed based on a type of the event. In a fifth example of the method, optionally including one or more or each of the first through fourth examples, the method further comprises: decreasing detection thresholds in proportion to a distance between the vehicle and the event. In a sixth example of the method, optionally including one or more or each of the first through fifth examples, the method further comprises: determining an attentiveness of a vehicle operator of the vehicle within the predetermined distance of the event.

The disclosure also provides support for a method executed by an application based on instructions stored in non-transitory memory of a controller of a vehicle, wherein the controller is configured to receive data wirelessly from a server regarding conditions outside of the vehicle, the method including detecting at least one event demanding an adjustment to a current vehicle maneuver, alerting one or more vehicles within a predetermined distance of the at least one event, and adjusting detection thresholds of the one or more vehicles. In a first example of the method, adjusting the detection thresholds comprises decreasing the detection thresholds by a fixed amount. In a second example of the method, optionally including the first example, the method further comprises: monitoring a condition of a vehicle operator of each of the one or more vehicles, and determining an attentiveness of the vehicle operator based on the monitoring. In a third example of the method, optionally including one or both of the first and second examples, the detection thresholds comprise at least a distraction threshold, wherein exceeding the distraction threshold results in the controller providing an alert to the vehicle operator to return their gaze to a vehicle travel path. In a fourth example of the method, optionally including one or more or each of the first through third examples, the at least one event is a distracted vehicle operator, wherein the distracted vehicle operator comprises a gaze that deviates from the vehicle travel path at a frequency or a duration greater than a distraction threshold.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices. The methods may be performed by executing stored instructions with one or more logic devices (e.g., processors) in combination with one or more additional hardware elements, such as storage devices, memory, hardware network interfaces/antennas, switches, actuators, clock circuits, et cetera. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” et cetera are used merely as labels, and are not intended to impose numerical requirements or a particular positional order on their objects. The following claims particularly point out subject matter from the above disclosure that is regarded as novel and non-obvious.

1. A method, comprising:
determining a presence of an inattentive vehicle operator in a first vehicle; and
transmitting to one or more vehicles within a predetermined distance of the first vehicle the presence of the inattentive vehicle operator.

2. The method of claim 1, wherein the inattentive vehicle operator is determined based on a comparison of current maneuvers to expected maneuvers.

3. The method of claim 1, wherein the transmitting is automatic.

4. The method of claim 1, further comprising adjusting operating parameters of the one or more vehicles in response to the presence of the inattentive vehicle operator.

5. The method of claim 4, wherein adjusting operating parameters comprises decreasing detection thresholds.

6. The method of claim 4, wherein adjusting operating parameters comprises displaying an alert to a vehicle operator and adjusting a volume, a sound, and a haptic feedback of the alert.

7. The method of claim 1, further comprising determining a presence of an event and transmitting to the one or more vehicles within the predetermined distance of a presence of the event.

8. The method of claim 1, wherein the transmitting further comprises a location and a type of event.

9. A method executed by an application hosted on a cloud, comprising:
automatically transmitting an alert to a vehicle within a predetermined distance of an event; and
adjusting one or more detection thresholds based on the event.

10. The method of claim 9, wherein the event comprises one or more of an inattentive driver, a caution zone, and a hard-stop.

11. The method of claim 9, further comprising adjusting vehicle operating parameters in response to the alert.

12. The method of claim 9, wherein the detection thresholds comprises at least a distraction threshold, wherein a duration or a frequency in which a gaze of a vehicle operator shifts away from a travel path of the vehicle is compared to the distraction threshold.

13. The method of claim 12, wherein the distraction threshold is reduced in response to the event.

14. The method of claim 9, further comprising decreasing detection thresholds in proportion to a distance between the vehicle and the event, wherein an amount the detection thresholds is reduced increases as the distance decreases.

15. The method of claim 9, further comprising determining an attentiveness of a vehicle operator of the vehicle within the predetermined distance of the event.

16. A method executed by an application based on instructions stored in non-transitory memory of a controller of a vehicle, wherein the controller is configured to receive data wirelessly from a server regarding conditions outside of the vehicle, the method, comprising:
detecting at least one event demanding an adjustment to a current vehicle maneuver;
alerting one or more vehicles within a predetermined distance of the at least one event; and
adjusting detection thresholds of the one or more vehicles.

17. The method of claim 16, wherein adjusting the detection thresholds comprises decreasing the detection thresholds by a fixed amount.

18. The method of claim 16, further comprising monitoring a condition of a vehicle operator of each of the one or more vehicles, and determining an attentiveness of the vehicle operator based on the monitoring.

19. The method of claim 16, wherein the detection thresholds comprise at least a distraction threshold, wherein exceeding the distraction threshold results in the controller providing an alert to a vehicle operator to return their gaze to a vehicle travel path.

20. The method of claim 16, wherein the at least one event is a distracted vehicle operator, wherein the distracted vehicle operator comprises a gaze that deviates from a vehicle travel path at a frequency or a duration greater than a distraction threshold.
